(19) United States
(12) Patent Application Publication
(10) Pub. No.: US 2002/0187226 A1
(43) Pub. Date: Dec. 12, 2002

(54) Method and apparatus for preparation of food product

(76) Inventors: Peter J. Wilk, New York, NY (US); Joshua Weisberger, Englewood, NJ (US)

Correspondence Address: R. Neil Sudol, Coleman Sudol Sapone, P.C., 714 Colorado Avenue, Bridgeport, CT, 06605-1601, US

(21) Appl. No.: 09/879,328

(22) Filed: Jun. 12, 2001

(51) Int. Cl. A23L 1/31

(52) U.S. Cl. 426/281

(57) ABSTRACT

A bagel filling kit includes a plurality of hollow tubular members, and a plurality of plunger members insertable into respective ones of the tubular members. The tubular members may be preloaded with respective charges of flowable comestible materials. Optionally, the plunger members are partially inserted into respective tubular members. Where the tubular members are preloaded, the user need only select a tubular member with a desired filling, insert a nozzle end of the tubular member into a hole in a bagel, where the hole communicates with a chamber inside the bagel, and push the plunger to thereby eject the filling material into the bagel.

### BACKGROUND OF THE INVENTION

This invention relates to a method for preparing a food product. More particularly, this invention relates to a method useful in preparing a filled food product. The invention also relates to an associated apparatus for preparing a food product. The apparatus is especially useful in preparing discrete food articles such as filled bagels.

The tastiest parts of certain baked food products such as muffins and bagels are those which are browned owing to exposure to an oven's convection currents. In eating muffins, people frequently separate the crowns from the bodies of the muffins in order to savor the enhanced flavor of the crowns. Likewise, in eating bagels, some people characteristically remove the inner, doughy parts of the bagel and eat only the shell, either alone or with filling such as a cream cheese and scallion spread or a salmon spread. Where a bagel is used to make a sandwich type food item, the hollowing out of the bagel provides the additional advantage of reducing the amount of filling that is squeezed out from between the bagel halves when the consumer bites into the bagel. Concomitantly, a hollow bagel is able to accommodate a greater amount of filling material.

A problem with the conventional manual method of removing dough from the interior of a bagel is inconvenience to the consumer. Another problem is waste that occurs when the removed interior dough is discarded rather than eaten.

Although certain food products such as doughnuts are frequently made with hollow interiors, into which a cream or fruit filling may be deposited, the method by which that hollow interior is formed is not applicable to bagels. Doughnuts can be made from a dough which separates during deep frying to produce an interior chamber. Bagels are cooked by an initial boiling step and a subsequent baking step. Bagels with hollow interiors will not naturally form during the two-step cooking process.

U.S. Pat. No. 5,807,599 describes a method for making a food product which utilizes an aliquot of dough disposed in a predetermined shape about a cooking member made of a material which has a chemical composition essentially impervious to cooking temperatures. The dough is cooked, e.g., boiled or baked, at a predetermined temperature for a predetermined period. The cooking member is maintained in the dough during the cooking thereof. After the cooking of the dough at the predetermined temperature for the predetermined period, the cooking member is removed from the cooked dough, thereby creating a chamber in the cooked dough.

Generally, as described in U.S. Pat. No. 5,807,599, the dough is molded about the cooking member to form the predetermined dough shape about the cooking member. Alternatively, the cooking member may be inserted or pressed into a lump of the dough.

According to U.S. Pat. No. 5,807,599, the cooking member is an elongate member made of a flexible material such as silicone. In that case, the elongate member may be bent to assume a desired form such as a circle. The dough generally conforms to the bent cooking member. The dough has a toroidal shape when the cooking member is bent into a circle.

As disclosed in U.S. Pat. No. 5,807,599, an end of the elongate member is left protruding from the uncooked dough form. After the dough is cooked, the elongate member is removed from the dough by grasping the protruding end of the elongate member and pulling the elongate member from the cooked dough. An edible filling may be injected or otherwise deposited into the chamber of the hollow dough cooked product after the pulling of the elongate member from the cooked dough.

### OBJECTS OF THE INVENTION

An object of the present invention is to provide a method and/or an associated apparatus useful in the production of a food product having an internal chamber containing an edible composition.

Another, more specific, object of the present invention is to provide a method and/or an associated apparatus for injecting a flowable edible composition into a food product having an internal chamber.

A further specific object of the present invention is to provide a method and/or an associated apparatus for producing an uncooked food product including dough disposed about a removable cooking insert.

It is an additional object of the present invention to provide such a method and/or apparatus which is useful in producing a hollow bagel provided with a filling.

A supplemental object of the present invention is to provide an automated method of manufacturing a food product which is provided with a filling.

These and other objects of the present invention will be apparent from the descriptions and illustrations herein. It is to be noted that each of the above objects is attained by at least one embodiment of the invention. However, no embodiment of the invention need attain all of the above-listed objects.

### SUMMARY OF THE INVENTION

A bagel filling kit comprises, in accordance with the present invention, a plurality of hollow tubular members, and a plurality of plunger members insertable into respective ones of the tubular members. The tubular members may be preloaded with respective charges of flowable comestible materials. The flowable comestible materials may include such foods as tuna fish salad, whitefish salad, salmon fish salad, chopped liver salad, various cream cheese or tofu pastes.

Optionally, the plunger members are partially inserted into respective tubular members. Where the tubular members are preloaded, the user need only select a tubular member with a desired filling, insert a nozzle end of the tubular member into a hole in a bagel, where the hole communicates with a chamber inside the bagel, and push the plunger to thereby eject the filling material into the bagel. The tubular member, plunger and charge of comestible material may be designed as a single-use, disposable assembly. In that case, the charge of comestible material is advantageously premeasured to fill exactly one bagel.

Pursuant to another feature of the present invention, the tubular members are arcuate. That shape facilitates an insertion of a tubular member through a hole in a bagel into a toroidal chamber formed in the bagel, as discussed in U.S. Pat. No. 5,807,599. Where the tubular member is arcuate, the shaft or the plunger member may be either substantially rigid with the same arcuate shape, or resiliently flexible. In the latter case, the flexibility of the plunger shaft facilitates a conformation of the plunger member to the lumen of the tubular member.

Pursuant to a further feature of the present invention, the kit additionally comprises a plurality of handles removably attachable to respective tubular members. In a simple embodiment, the tubular members are each provided with at least one aperture for receiving a part (e.g., a flange) of a respective one of the handles. In an alternative embodiment, the tubular members are provided with attached handles. In any event, a handle functions to facilitate manipulation of the tubular member and is especially useful where the tubular member is loaded with a charge of comestible material by the ultimate user. The user grips the tubular member by the handle and pushes the tubular member to partially into and along a bed of flowable comestible filling material, thereby forcing the filling material into the tubular member. This loading process may be undertaken with the plunger member attached to or detached from the tubular member.

Accordingly, a method pursuant to the present invention for producing a filled food product works on a piece of comestible material or food product (e.g., a bagel) provided with a preformed internal chamber and an access opening communicating with the internal chamber. The method utilizes a hollow tubular member with at least one open end, a plunger member, and a quantity of flowable comestible filling material. The hollow tubular member is manipulated to move the open end of the tubular member along the quantity of flowable comestible material so that some of the flowable comestible material enters the tubular member to load the tubular member. Thereafter a tip of the loaded tubular member is inserted through the access opening in the food product and the plunger member is pushed to eject flowable comestible material from the loaded tubular member into the internal chamber of the food product. Subsequently, the tip of the tubular member is removed from the filled food product. Generally, the plunger member is inserted into an end of the tubular member opposite the tip prior to the pushing of the plunger member to eject the flowable material into the chamber of the food product.

As discussed above with respect to the kit, a handle may be attached to the tubular member prior to the manipulating of the tubular member.

A method for forming a food product (such as a hollow bagel preform) utilizes, in accordance with the present invention, a cooking insert having a 9- or 6-shape including a generally circular portion and a tail portion. The method comprises disposing a first piece of generally flattened dough material on a support having a projection so that a central region of the first piece of generally flattened dough material is located over the projection. The cooking insert is then placed on the first piece of generally flattened dough material so that the circular portion of the insert encircles the central region of the dough piece and the projection of the underlying support. A second piece of generally flattened dough material is deposited over the first piece of generally flattened dough material and at least the circular portion of the placed cooking insert. Subsequently, the second piece of generally flattened dough material is pressed to the first piece of generally flattened dough material along an inner circle inside the circular portion of the cooking insert and along an outer circle outside the circular portion of the cooking insert, thereby sealing the first and the second piece of generally flattened dough material to one another along radially inner and outer zones. Also subsequent to the deposition of the second piece of generally flattened dough material over the first piece of generally flattened dough material, the first piece of generally flattened dough material and the second piece of generally flattened dough material are cut proximate to and along the inner circle and the outer circle along which the pressing occurs. The cutting of the dough may take place concurrently with, prior to, or subsequently to the pressing of the first and the second piece of generally flattened dough material to one another.

It is contemplated that this manufacturing method is implement chiefly automatically. In particular, the pressing of the second piece of generally flattened dough material to the first piece of generally flattened dough material and the cutting of the first piece of generally flattened dough material and the second piece of generally flattened dough material are implemented automatically. In addition, the disposing of the first piece of generally flattened dough material and the depositing of the second piece of generally flattened dough material may be performed automatically.

A machine for filling a comestible product such as a hollow bagel comprises, in accordance with the present invention, a carousel having an axis or rotation and a plurality of tubular members attached to the carousel, the tubular members being oriented parallel to the axis and in angularly spaced relation to one another about the axis. A plurality of pistons each disposed in a respective one of the tubular members, while an actuator is disposed in operative engagement with the pistons for shifting the pistons parallel to the axis to eject flowable material through openings at lower ends of the tubular members. Means may be operatively connected to the tubular members for limiting the amounts of ejected flowable material to a predetermined fixed quantity.

### BRIEF DESCRIPTION OF THE DRAWINGS

FIG. 1 is a diagram of successive steps in a method for making a hollow bagel.

FIG. 2 is a schematic side elevational view of an automated assembly-line-type machine for forming a bagel preform which is cooked in boiling and baking steps illustrated in FIG. 1.

FIG. 3 is a schematic partial top plan view of a conveyor shown in FIG. 2.

FIG. 4 is a schematic side elevational view of an automated assembly-line-type machine for automatically removing an arcuate flexible insert or cooking member from a cooked bagel.

FIG. 5 is a diagram of successive steps in a method for making a bagel with a filled center.

FIG. 6 is a schematic side perspective view of an assembly for filling a bagel in accordance with the present invention, showing the assembly in a disassembled state.

FIG. 7 is a view similar to FIG. 6, showing the filling assembly of that drawing figure in an assembled and loaded state.

FIG. 8 is a view similar to FIG. 7, showing the filling assembly of that drawing figure in a filling discharged state.

FIG. 9 is a schematic side perspective view of the assembled and loaded filling assembly of FIG. 8 for injecting a filling into a bagel formed pursuant to the method of FIGS. 1-4.

FIG. 10 is a schematic side perspective view of a modified filling injection assembly in accordance with the invention.

FIG. 11 is a schematic side perspective view of a modified tubular filling member in accordance with the invention.

FIG. 12 is a pair of side perspective views of a flexible resilient plunger member showing that member in a straight and a flexed configuration for use with the tubular member of FIG. 11.

FIG. 13 is a schematic perspective view of a kit of filling assemblies shown singularly in FIG. 6.

FIG. 14 is a schematic perspective view of a kit of assembled filling assemblies, in accordance with the present invention.

FIG. 15 is a exploded perspective view of a tubular member and an associated handle of another filling assembly in accordance with the present invention.

FIG. 16 is a schematic perspective view of the tubular member and handle of FIG. 15 coupled to one another.

FIG. 17 is a schematic perspective view of the tubular member and handle of FIG. 16, showing a step in the use of that assembly in a process for filling a bagel with a chamber.

FIG. 18 is a exploded perspective view of a tubular member and an associated handle of yet another filling assembly in accordance with the present invention.

FIG. 19 is a schematic perspective view of the tubular member and handle of FIG. 18 coupled to one another.

FIG. 20 is a diagram of successive steps in a method for making a bagel with a hollowed center, in accordance with the present invention.

FIG. 21 is a schematic perspective view of a support plate for forming a doughy bagel preform surrounding a cooking insert, in accordance with the present invention.

FIG. 22 is partially a schematic perspective view and partially a block diagram of a device for forming doughy bagel preform surrounding a cooking insert, in accordance with the present invention.

FIGS. 23A through 23F are schematic cross-sectional views of a support plate or platform, dough sections and selected parts of the device of FIG. 22, showing successive steps in the production of a doughy bagel preform using the device of FIG. 22.

FIG. 24 is a schematic perspective view, partially broken away, of a manually operated bagel filling machine in accordance with the present invention.

FIG. 25 is a schematic perspective view of another manually operated bagel filling machine in accordance with the present invention.

### DESCRIPTION OF THE PREFERRED EMBODIMENTS

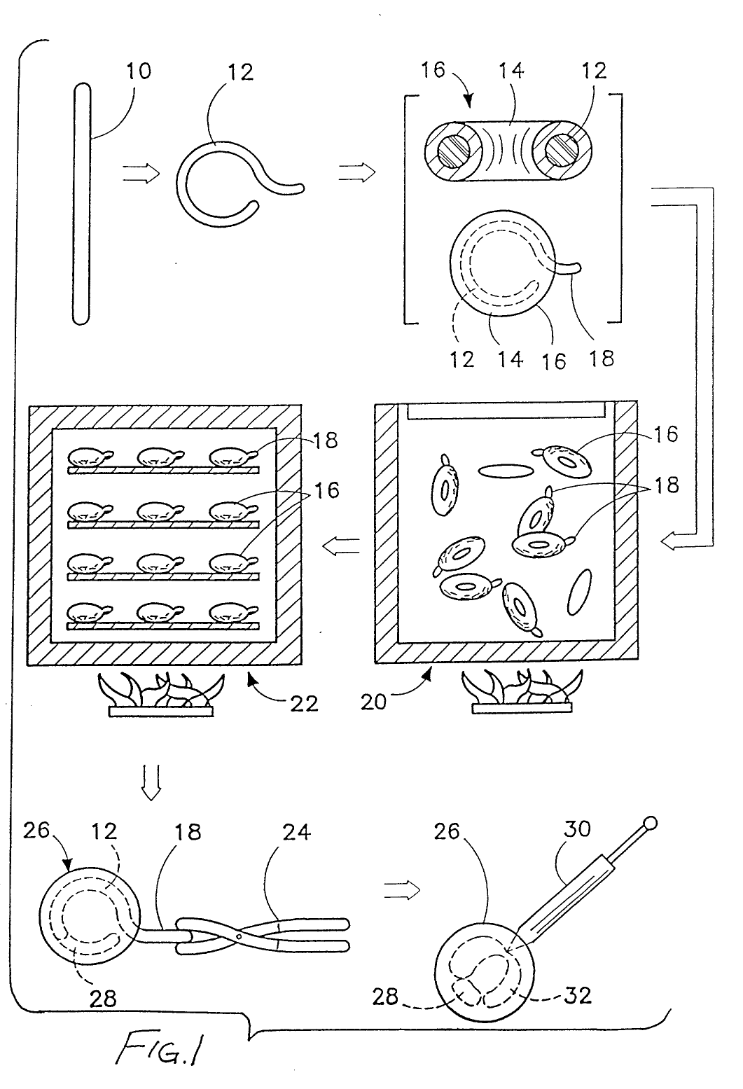

As illustrated in FIG. 1, an elongate cooking member 10 for use in baking a hollow cooked food product such as a bagel is made of a flexible low-friction material which is impervious to boiling and baking temperatures. Such a material is silicone with a durometer hardness measurement of less than 30.

Cooking member 10 is bent into an arcuate, specifically a circular, form 12. Then a predetermined aliquot of bagel dough 14 is molded about the circularly bent cooking member 12 to produce a toroidal dough preform 16 in which the cooking member 12 is embedded. An end portion 18 of cooking member 10 protrudes from preform 16.

Preform 16 including circularly bent cooking member 12 is now ready for cooking by traditional steps of boiling, schematically represented at 20, and baking, schematically represented at 22 in FIG. 1. After the bagel preform has been baked, protruding end portion 18 is grasped, e.g., by a pliers 24 and pulled from the baked food item 26 to generate a hollow chamber 28.

As further illustrated in FIG. 1, a syringe 30 or other instrument may be subsequently used to inject or otherwise deposit a filling material 32 such as cream cheese or minced meat into chamber 28. An alternative filling instrument (not illustrated) would have an elongate flexible tube which is inserted into chamber 28 and withdrawn as filling material is fed through the tube to an opening at a free end thereof. This flexible tube would advantageously be provided at a distal end with an enlarged smoothly curved surface to guide the tube along hollow chamber 28. Such a guide surface may be a surface of a balloon attached to the distal end of the flexible tube. Optionally, the balloon is alternately inflatable and deflatable. The balloon or other camming-type surface prevents the distal tip of the flexible tube from catching on the cooked dough material of the baked food item 26.

It is to be noted that preform 16 may take a form other than toroidal. a food product produced from the preform may be elongate.

The use of a cooking member as described hereinabove may be used to produce hollow food products other than bagels, such as muffins and doughnuts. Also, preform 16 with a straight or bent cooking member 12 may be produced at a first, central, location such as a factory and shipped to remote locations (bakeries) for cooking.

It is generally contemplated that cooking element 10 has a predetermined substantially constant size. However, if a suitable material is available, it would be possible to make the cooking member as an inflatable balloon member. In that event, heating of the balloon and the gases (air) inside it during the cooking process will expand the balloon member further, if only relatively incrementally.

FIG. 2 schematically depicts a machine for automatically forming preform 16. a conveyor belt 34 is provided with a plurality of spaced bottom mold halves 36 each in turn provided with a plurality of vertically oriented pins 38. Pins 38 are slidably attached to the respective bottom mold halves 36 in order to move from a lowered neutral or storage position indicated at 40 to an elevated arrest configuration indicated at 42. Pins 38 are shifted vertically upward from lowered neutral position 40 to elevated arrest configuration 42 owing to a camming action arising from the motion of conveyor belt 34, mold halves 36 and pins 38 along a camming surface 44.

At a first station along a path of movement of belt 34 is disposed a first dough hopper 46. a door 48 provided at a lower end of hopper 46 prevents a deposition of dough onto conveyor belt 34 unless a mold half 36 is located below the hopper. At that time, door 48 is shifted sideways, as indicated by an arrow 48. After a predetermined amount of dough (not shown) has fallen from hopper 46, door 48 is shifted back into the illustrated closure position below the lower end of the hopper. a cutting edge 50 at one end of door 48 severs the predetermined amount of falling dough from the dough remaining in hopper 46.

At a second station along a path of movement of belt 34 is disposed a device 52 for bending cooking member 10 into a generally circular form. An automatically driven flexible rod 54 pushes cooking member 10 through a helical passageway or groove 56 in device 52 until the cooking member rests in a circular configuration on a door 58 at a lower end of device 52. Upon the arrival of a mold half 36 directly below device 52, door 58 is moved laterally to permit a deposition of the bent cooking member onto the dough placed into the mold half at hopper 46. The entire device 52 may be shifted temporarily downwardly to facilitate the proper deposition of the circular cooking member 10 onto the dough and inside a ring of elevated pins 28. Pins 38 serve to maintain cooking member in a curved configuration during the deposition of another predetermined amount of dough 61 from a second hopper 60 over the cooking member 10 and the first amount of dough deposited by hopper 46. Hopper 60 is provided with a reciprocatable door 62 having a cutting edge 64.

At a subsequent station along the path of movement of belt 34, an upper mold half 66 having a cavity 68 is pressed onto the dough deposited by hopper 60 to shape the two aliquots of dough and connect them to one another. To that end, mold half 66 and/or mold half 36 may be provided with vibrators and other devices for ensuring that the two dough portions are intertwined with one another. Concurrently with the above described shaping or molding operation, pins 38 are withdrawn from the combined dough aliquots. This may be accomplished by several methods which will occur to one skilled in the art. a vacuum device (not shown) may ascend and contact the bottom of lower mold half 36 via a rubber seal ring. Application of vacuum will draw pins 38 from the mold. Alternatively, an electromagnet (not shown) may be placed against the bottom of mold half 36 and energized to attach pins 38, which are advantageously made of stainless steel for contact with foodstuffs. The electromagnet may then be lowered, thereby withdrawing the pins.

It is to be noted that the above-described basic assembly line technique may be modified in various ways. For example, hopper 46 may be eliminated, with all of the dough being provided by hopper 60. In that case, a removable lower support is provided for the circularly bent cooking member 10. Such a lower support may comprise a plurality of additional sliding pins. The pins allow the dough to flow around the cooking member during dough deposition and additionally allow the dough to flow together and close up upon the application of molding pressure by upper mold half 66.

As illustrated in FIG. 3, pins 38 are disposed in a generally circular configuration in a toroidal cavity 70 which is a mirror image of cavity 68 in upper mold half 66. Cavity 70 has an extension 71 for receiving end portion 18 (see FIG. 1) of cooking member 10.

After the formation of preform 16 as described above with reference to FIG. 2, boiling and baking steps are performed as described hereinabove with reference to FIG. 1. These steps may be implemented in accordance with conventional processing techniques.

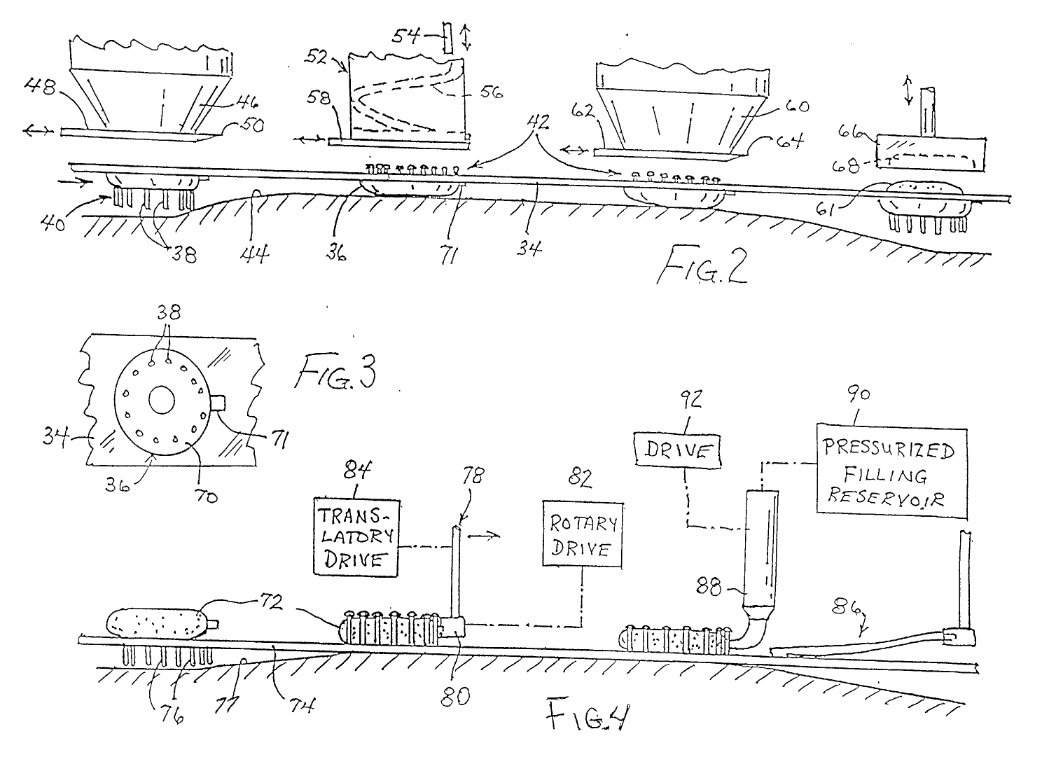

FIG. 4 shows machine removal of cooking member 10 from a cooked bagel 72. Bagel 72 is deposited on a conveyor belt 74 inside a ring of lowered retaining pins 76. As conveyor 74 moves along its pre-established path of transport, pins 76 are elevated by a camming surface 77 so that the pins substantially surround bagel 72, particularly on a side thereof from which end portion 18 of cooking member protrudes from bagel 72. a grasping device 78 including a chuck or clamp 80 then grips end portion 18, owing to operation of a rotary drive 82. a translatory drive 84 then moves grasping device 78 away from bagel 72 while the bagel is held by retaining pins 76. The removed cooking member 10 is illustrated at 86. a nozzle 88 connected to a pressurized filling reservoir 90 is then moved into position by a drive 92 and injects comestible filling material inside the hollow bagel 72. Techniques for injecting fluidized comestible compositions into food preforms are well known to those skilled in the art. Subsequent to the injection or filling operation, the completed filled bagel is mechanically jostled by a jostling mechanism (not illustrated), which may take the form of one or more pneumatic jets, delivering puffs of air. This jostling aids in the disengagement of pins 76 concurrent with recession of camming surface 77 following final processing on belt 74, which disengagement may also be vacuum or magnetically assisted as described above. Pins 38 and 76 will advantageously be given a tapered or conical head shape, to facilitate withdrawal from dough, and minimize damage to the finished product.

It is to be noted that grasping device 78 may approach bagel 72 from a trailing side thereof. In that case, bagel 72 is deposited onto conveyor belt 74 so that end portion 18 points in an upstream direction, i.e., counter to the direction of transport of belt 74. Pins 76 are clustered by the end portion 18, on an upstream or trailing side of bagel 72, for holding the bagel while grasping device 78 holds cooking member 10. The movement of conveyor belt 74 serves to separate bagel 72 and grasping device 78 and remove the cooking member 10.

In an alternative process for producing a hollow comestible product such as a bagel, the function of cooking member 10 is performed by a generally rigid insert made of a dissolvable material. This material should be biologically compatible or edible, such as ice, sugar, frozen gelatin, or salt. Where a hollow bagel is cooked by boiling and baking steps, the insert may be a generally circular piece of ice with a sugar and/or salt content selected to control the rate of dissolution of the insert in the hot water of the boiling step. The salt and/or sugar content will also be selected to vary the flavoring of the eventual food product. For example, the insert might have a core of pure water and an outer layer which has a substantial sugar and/or salt concentration. In that case, the higher sugar and/or salt concentration of the outer layer of the cooking insert delays the disintegration and dissolution of the insert during the initial stages of a boiling procedure. In addition, the salt and/or sugar may be deposited in a greater or lesser concentration on an inner surface of the food product, thereby providing a desirable flavoring.

a dissolvable cooking insert may itself be hollow. During a molding procedure, dough is placed about the cooking insert so as to surround the insert. Mold forms may then close about the dough and the embedded cooking insert, to shaped the dough into a desired form.

In another alternative process for producing a comestible product such as a bagel, the function of cooking member 10 is performed by an insert made of an edible material such as a tuna fish and/or a ham and cream cheese composition. Generally, the food material used for the cooking member or insert should be capable of being hardened, for example, by a freezing process. First the edible insert material is sculpted, molded, or otherwise shaped into the desired form. Then the shaped material is hardened, for example, by a freezing process. Alternatively, a layer of a digestible material, such as sugar or salt or a biocompatible monomer or polymer, may be formed around the basic material and hardened into a shell by a transfer of energy such as heat energy (freezing or convection cooking), electromagnetic energy (infrared radiation), vibrational energy (ultrasonic pressure waves), etc.

After the hardening of the insert or a shell layer thereof, dough is molded about the insert. The entire preform is then subjected to a cooling process. Subsequently, the insert remains in the cooking bagel (or other food product) as a filling. Of course, the cooking of the dough may also cook the material of the insert.

It is to be noted that the same mechanism for automatically removing a cooking member from a cooked bagel may be used to remove the cooking member from the dough prior to the cooking thereof. The dough is optionally chilled prior to removal of the cooking member to facilitate maintenance of the shape of the dough during and after the removal of the cooking member. In general, a flexible cooking member made of heat impervious material may be removed from an aliquot of dough before or after the cooking process.

FIG. 5 illustrates successive steps in a method for producing multiple bagel-type food products 102 each having a filling material 104 disposed in a center opening (not separately designated. a predetermined amount of dough 106 is molded or otherwise disposed about an elongate cooking member 108 to form a preform 110. Cooking member 108 is made of a material impervious to cooking temperatures.

Preform 110 comprises dough 106 molded into a cylindrical shape 112 coaxially surrounding cooking member 108. After the formation of preform 110, the preform is placed in a baking oven 114 where the dough 106 of preform is baked. Thereafter, the preform is removed from baking oven 114 and the cooking member 108 is removed, as indicated by an arrow 116, thereby producing a baked farinaceous tubular intermediate product 118. At that juncture, a nozzle 120 of a hydraulic type injector 122 is inserted into a lumen or chamber 124 in intermediate product 118. Injector 122 is actuated to inject comestible food composition or filling 104 into lumen 124. Subsequently, tubular intermediate product 118 with a substantially predetermined quantity of injected food composition 104 is placed on a platen 126 of a slicing device 128 having a pivotally movable flap 130 carrying a plurality of parallel blades 132. Flap 130 is pivoted, as indicated by an arrow 134, to slice tubular intermediate product 118 with the injected food composition 104 in a plurality of spaced planes (not shown). Upon a pivoting of flap 130 back into a rest position, as shown at 136, multiple bagel-type food products 102 each having a filling material 104 disposed in a center opening (not separately designated) are produced.

Alternative mechanisms are well within the ordinary skill in the art for holding a cooked bagel, on the one hand, and the cooking member 10, on the other hand, and for pulling the bagel and the cooking member in opposite directions to extricate the cooking member from the bagel. Where a multiplicity of bagels are disposed in a line so that the end portions 18 of the respective cooking members are pointed in the same direction, a plate may be used to retain all of the bagels simultaneously. Similarly, a pair of bars may be used for clamping all of the protruding ends of the cooking members simultaneously. Various drives are operatively connected to the bars for shifting them together towards the bagels, for clamping the bars and subsequently separating them from one another, and for moving the bars relative to the retaining plate and the held bagels.

Other mechanisms will occur to one skilled in the art for automatically bending cooking member 10 into an arcuate form and molding dough about the bent cooking member. For instance, cooking member 10 may be deposited on an inflated balloon inside a mold cavity. As dough is injected into the mold cavity, the balloon is deflated and withdrawn from the cavity. It is to be understood that the cooking of bagel dough to produce bagels need not include a boiling step, as is frequently the case in contemporary bagel production methods.

Also, in producing a bagel having an internal chamber for receiving an edible composition, the dough may be molded about an elongate flexible cooking member disposed in a linear configuration. The cooking member with the surrounding shaped dough is then bent into a desired circular configuration. In general, some adjustment in the configuration of the preform may be made after the placement of the dough about the cooking member, at least where the cooking member is a flexible element or a manipulable edible composition.

It is also within the contemplation of the present invention that the cooking member or insert is a flexible balloon type member which may be filled with oil or other fluid capable of withstanding boiling temperatures without volatilizing. The oil is siphoned off prior to removing the balloon or bag from the cooked or uncooked food product. In this case, the friction between the deflated cooking member and the doughy body may be so small that the restraint for holding the doughy body may simply be frictional forces of a surface on which the doughy body rests.

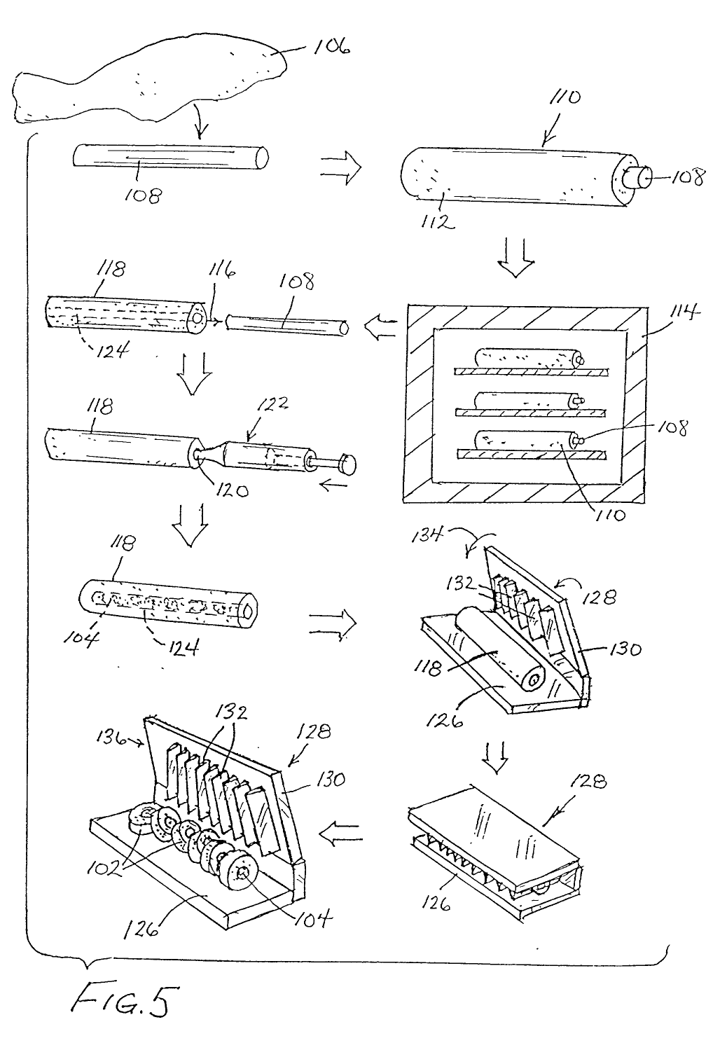

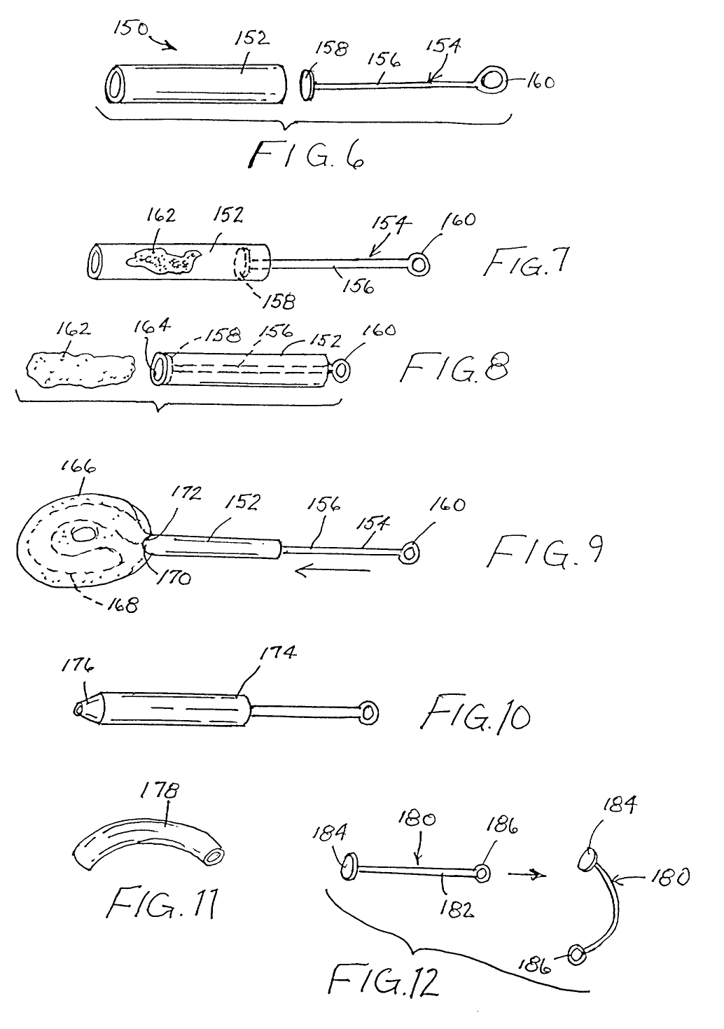

FIG. 6 depicts a filling injection assembly 150 comprising a tubular member 152 and a plunger 154 having an elongate shaft 156 provided at one end with a piston disk 158 and at an opposite end with a ring-shaped handle grip 160. FIG. 7 shows the filling injection assembly 150 of FIG. 6 in an assembled and loaded state. Piston disk 158 is disposed inside tubular member 152 as is a charge of a comestible filling material 162. FIG. 8 shows the piston assembly 150 of FIG. 7 after plunger 154 has been pushed in a distal direction towards an opening or mouth 164 of tubular member 152. The charge of comestible filling material 162 is shown as ejected or discharged from tubular member 152 through opening or mouth 164. FIG. 9 shows the loaded filling injection assembly of FIG. 7 disposed in a filling position relative to a bagel 166 provided with a toroidal chamber 168. Distal tip 170 of tubular member 152 is inserted through a hole 172 in bagel, which hole communicates with chamber 168.

As illustrated in FIG. 10, a tubular filing injection member 174 may be formed at a distal end with a tapered or conical section 176 for facilitating the insertion of that distal end through a hole formed in a bagel as discussed hereinabove. As depicted in FIG. 11, a tubular injection member 178 may be preformed to have an arcuate or curved configuration, whereby the entire tubular member and not just the distal tip thereof may be inserted through a bagel hole into a toroidal bagel chamber. To that end, tubular member 178 is provided with a plunger member 180 (FIG. 12) have a resiliently flexible shaft 182 connected at one end to a piston plate 184 and at an opposite end to a ring-shaped handle grip 186.

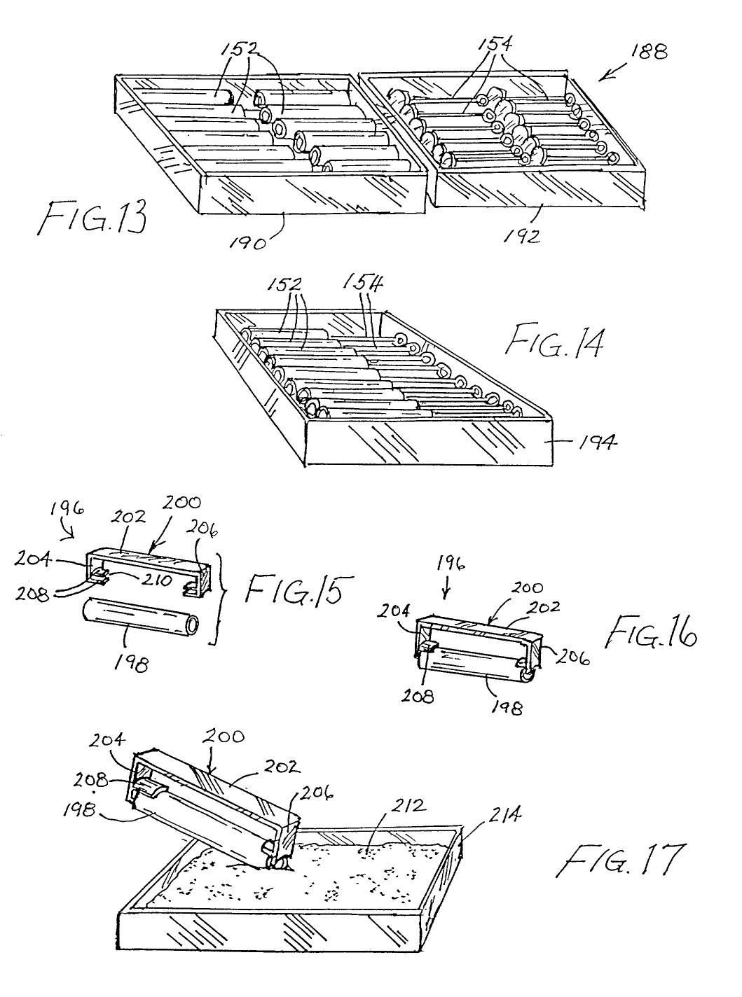

In one business method for implementing bagel production, the filling injection assembly 150 of FIG. 6 is shipped to retail bagel stores in a packaged kit 188 as shown in FIG. 13. Multiple tubular members 152 (or 174, 178) and a like number of plungers 154 (or 180) are shipped together in different containers 190 and 192 or a common container 194 as illustrated in FIG. 14. Thus, tubular members 152 and plungers 154 of respective filling injection assemblies 150 may be shipped separately, in a disassembled state (FIG. 13) or, alternatively, connected to one another (FIG. 14).

The present business method contemplates that tubular filling injection members 152,176 or 178 are shipped either in an empty state or preloaded with respective charges of bagel fillings. In the latter case, each package or container 190 or 194 may contain tubular filling injection members 152 (or 176 or 178) loaded with the same kind or different kinds of filling materials. Of course, where tubular filling injection members 152, 176 or 178 are preloaded with flowable comestible filling materials, it will be necessary in many case to refrigerate the entire packages during shipment.

As shown in FIG. 15, another assembly 196 for injecting filling material into hollowed bagels includes a tubular member 198 and a handle or grip 200. Grip 200 includes a central body section 202 provided at opposite ends with respective planar flanges 204 and 206. Each flange 204 and 206 is in turn provided at a free end, opposite body section 202, with a pair of generally parallel, cylindrically arcuate fingers 208 spaced from one another by a gap 210 for receiving an end or edge portion of tubular member 198. FIGS. 16 and 17 show grip 200 attached to tubular member 198. Opposite ends of tubular member 198 are inserted into gaps 210 between fingers 208. To facilitate assembly of grips 200 to respective tubular members 198, flanges 204 and 206, as well as flanges 208 are made of a resilient material enable distortion of the flanges during an assembly operation.

FIG. 17 shows how the partially assembled filling injection assembly 196 of FIG. 16 is manipulated to load tubular member 198 with a desired filling at a retail establishment or even in the home. Grip 200 is held to enable the user to scoop an aliquot of flowable comestible filling material 212 from a bed (not separately designated) thereof on a container 214. During this procedure for loading tubular member 198 and thus assembly 196, tubular member 198 is angled slightly relative to the bed of filling material 212 and is dragged along the surface of the bed, thereby driving a controllable amount of the filling material into tubular member 198. Before or after the filling of tubular member 198 in this manner, a plunger member (not shown) is partially inserted into one end of the tubular member in anticipation of discharge into a bagel or other hollow food product.

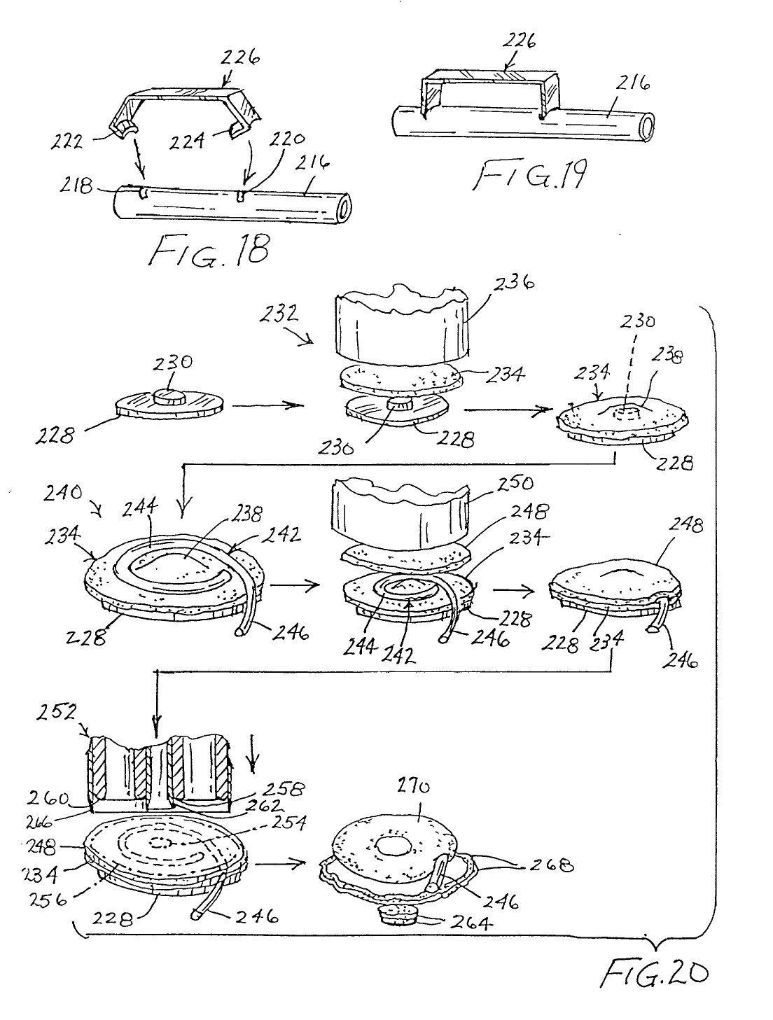

FIGS. 18 and 19 depict a modified filling injection assembly having a tubular member 216 provided in a side wall (not separately designated) with a pair of apertures 218 and 220 for receiving cylindrically arcuate flanges 222 and 224 of a handle or grip 226.

As depicted in FIG. 20, a method for forming a food product (such as a hollow bagel preform) utilizes a support 228 such as a plate provided with a projection 230. Support plate 228 have be disposed on a conveyor (not shown) for moving the plate between successive work stations. At a first work station 232, a first piece of generally flattened dough material 234 is disposed by a laying machine 236 on support plate 228 so that a central region 238 of the dough material 234 is located over projection 230. At a following work station 240, a 9- or 6-shaped cooking insert 242 is placed on dough piece 234 so that a generally circular portion 244 of cooking insert 242 encircles central region 238 of dough piece 234 and encircles projection 230 of support 228 and so that a tail portion 246 of the cooking insert extends beyond a periphery of dough piece 234. Then, a second piece of generally flattened dough material 248 is automatically deposited by a machine 250 over dough piece 234 and at least circular portion 244 of cooking insert 242. Subsequently, a combined cutter and closure device 252 operates to pressed the dough pieces 234 and 248 to one another along an inner circular zone 254 and an outer circular zone 256. Inner circular zone 254 is located inside circular portion 244 of cooking insert 242, while outer circular zone is located outside circular portion 244.

Device 252 includes an inner circular sealing lip 258 and an outer circular sealing lip 260 which cooperate with support plate 228 to mash or knead dough pieces 234 and 248 to one another along circular zones 254 and 256, respectively. Device 252 further includes an inner circular blade 262 and an outer circular blade 266. Inner blade 262 cooperates with support plate 228 and projection 230 to cut circular sections of dough 264 from dough pieces 234 and 248, while outer blade 266 cooperates with support plate 228 to slice dough rings 268 from the peripheries of dough pieces 234 and 248. Device 252 thus acts to form a toroidal dough mass 270 surrounding circular portion 244 of cooking insert 242.

Projection 230 functions at least in part to locate circular portion 244 of cooking insert 242 on dough piece 234. Projection 230 also serves to hold cooking insert 242 in position during subsequent operations, including the deposition of dough piece 248 and the cutting and sealing of dough pieces 234 and 248 by device 252. As illustrated in FIG. 21, the functions of projection 230 may be alternatively performed by a 6- or 9-shaped recess 272 in a support plate 274.

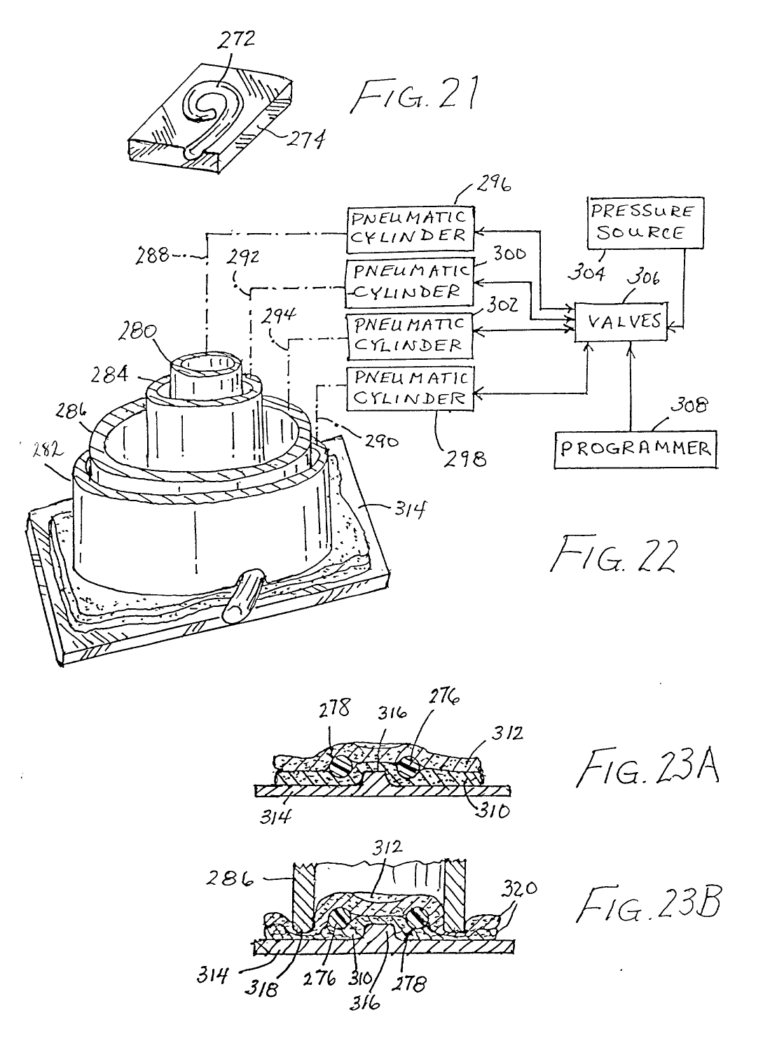

It is to be noted that support 228 and device 252 may embody numerous variations in structure and operation to facilitate the automatic sealing and cutting of dough pieces 234 and 248 along circular zones 254 and 256. Accordingly, the different parts of device 252 (lips 258, 260, blades 262, 266) may be rigidly connected to one another and collectively driven for substantially simultaneous operation. In one modification of this embodiment, the various parts of device 252 may be staggered with respect to one another to cause, for instance, a sealing of dough pieces 234 and 248 to one another along circular zones 254 and 256 prior to the cutting of the dough pieces by blades 262 and 266. Alternatively, as discussed in detail hereinafter with reference to FIGS. 22 et seq., the different parts of device 252 (lips 258, 260, blades 262, 266) may be movably connected to one another and separately driven for sequential operation.

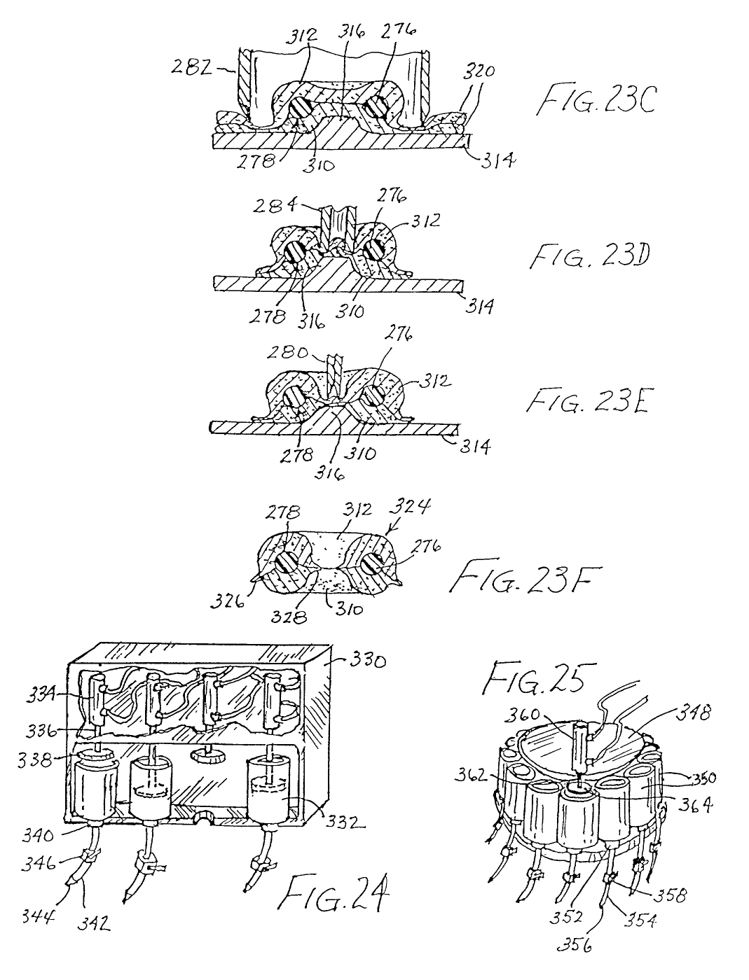

FIG. 22 shows a device for forming doughy bagel preform 324 (see FIG. 23F) surrounding a circular head portion 276 of a cooking insert 278. Device 22 includes a cylindrical inner blade or blade-holding member 280, a cylindrical outer blade or blade-holding member 282, and two cylindrical dough working or pressing members 284 and 286. Each member 280, 282, 284, and 286 is operatively connected by a respective mechanical linkage 288, 290, 292, 294 to a respective pneumatic cylinder 296, 298, 300, 302. Cylinders 296, 298, 300, 302 are selectively coupled to a source 304 of pressurized air and alternately to the atmosphere by a gang of valves 306 in turn operated by a programmer or controller 308.

FIG. 23A shows a pair of substantially flat dough pieces 310 and 312 sandwiching circular head portion 276 of cooking insert 278 and disposed therewith on a support plate 314 so that circular head portion 276 surrounds a generally centrally location projection 316 on plate 314. In a first step of a dough pressing and severing operation, shown in FIG. 23B, annular pressing member 286 is lowered to a position wherein annular regions or peripheries of dough pieces 310 and 312 are squeezed between a lower rim or edge 318 of pressing member 286 and support plate 314. The squeezed or pressed dough of pieces 310 and 312 are thereby worked together to seal the peripheries of the dough pieces to one another. Subsequently, pressing member 286 is raised and outer blade member 282 is lowered, as shown in FIG. 23C, to cut dough pieces 310 and 312 along the pressed or worked regions, on an outer side thereof, thus enabling separation and recycling of excess dough 320. Upon the severing of the excess dough 320 by outer blade member 282, pressing member 284 is then lowered, as shown in FIG. 23D, to press portions of dough pieces 310 and 312 inside circular head portion 276 into connective contact with one another. Thereafter, pressing member 284 is elevated and inner blade member 280 is lowered, as shown in FIG. 23E to sever circular central portions (not designated) of dough pieces 310 and 312. The resulting doughy bagel preform 324 is a substantially toroidal doughy mass surrounding circular head portion 276 of cooking insert 278. Annular doughy ribs or ridges 326 and 328 may remain in place during subsequent cooking operations. These ribs or ridges 326 and 328, owing to their thinness, become brittle during cooking and are generally broken off during subsequently handling. Alternatively, it is possible to provide further mechanical processing of the bagel preform 324 to knead rims or ridges 326 and 328 into the main dough mass, without separating the toroidallly deformed dough pieces 310 and 312.

FIG. 24 illustrates a bagel filling machine comprising a housing or frame 330 holding a plurality of cylindrical containers 332 of generally different comestible filling compositions, such as tuna fish salad, whitefish salad, salmon fish salad, chopped liver salad, various cream cheese or tofu pastes. Each container 332 is associated with a respective pneumatic cylinder 334 having a plunger 336 provided at a lower end with a pressure plate 338. Each pressure plate 338 is placed in contact with a movable lid or upper panel (not shown) of the respective filling container 332 for placing the filling in the container under pressure. Each container 332 is provided at a lower end with an outlet port 340, a hose 342, a nozzle 344, and a manually operable valve 346. a user merely inserts the nozzle 344 of a selected container 332 in a hole of a hollow cooked bagel and manipulates the respective valve 346 to inject the desired filling into the bagel.

FIG. 25 depicts an alternative bagel filling machine including a rotatable frame, turntable or carousel 348 carrying a multiplicity of cylindrical filling containers 350 in a circular array. Each filling container 350 is provided at a lower end with an outlet port 352, a hose 354, a nozzle 356, and a manually operable valve 358. The machine of FIG. 25 includes a single pneumatic cylinder 360 for alternately pressurizing the different containers 350 brought into registration or alignment with the pneumatic cylinder at a filling station (not designated). Cylinder 360 has a vertically oriented plunger element 362 provided at a lower end with a disk-shaped flange or pressure plate 364. Cylinder 360 is operatively connected to a valve (not shown) and a programmer or controller (not shown) which induces plunger 362 to retract when turntable or carousel is to be rotated to align a different filling container 350 with cylinder 360. Upon alignment, plunger is lowered to place pressure plate 364 into contact with a shiftable upper container panel (not shown) inside the newly aligned container 350. Plunger continues in a downward stroke until the pressure exerted equals a predetermined limit (as detected by a sensor, not shown). Upon registration and pressurization of a selected container 350, a user inserts the nozzle 356 of the selected container in a hole of a hollow cooked bagel and manipulates the respective valve 358 to inject the desired filling into the bagel.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. a bagel filling kit comprising:
a plurality of hollow tubular members; and
a plurality of plunger members insertable into respective ones of said tubular members.

2. The kit defined in claim 1 wherein said tubular members are loaded with respective charges of flowable comestible materials.

3. The kit defined in claim 2 wherein said plunger members are partially inserted into respective ones of said tubular members.

4. The kit defined in claim 3 wherein said charges are each premeasured to form a filling for a single bagel.

5. The kit defined in claim 1 wherein said tubular members are arcuate.

6. The kit defined in claim 5 wherein said plunger members have resiliently flexible shafts.

7. The kit defined in claim 1, further comprising a plurality of handles removably attachable to respective ones of said tubular members.

8. The kit defined in claim 7 wherein said tubular members are each provided with at least one aperture for receiving a part of a respective one of said handles.

9. The kit defined in claim 1 wherein said tubular members are provided with attached handles.

10. a method for producing a filled food product, comprising:
providing (a) a piece of comestible material provided with a preformed internal chamber and an access opening communicating with said internal chamber, (b) a hollow tubular member with at least one open end, (c) a plunger member, and (d) a quantity of flowable comestible material;
manipulating said hollow tubular member to move said open end along said quantity of flowable comestible material so that some of said flowable comestible material enters said tubular member to load said tubular member;
subsequent to the manipulating of said hollow tubular member, inserting a tip of the loaded tubular member through said access opening;
after the inserting of said tip, pushing said plunger member to eject flowable comestible material from said loaded tubular member into said internal chamber; and
after the pushing of said plunger member and the ejection of flowable material into said internal chamber, removing said tip from said piece of comestible material.

11. The method defined in claim 10, further comprising inserting said plunger member into an end of said tubular member opposite said tip prior to the pushing of said plunger member.

12. The method defined in claim 11 wherein the inserting of said plunger into said tubular member is performed after the manipulating of said hollow tubular member.

13. The method defined in claim 10 wherein said open end is at said tip.

14. The method defined in claim 10, further comprising attaching a handle to said tubular member prior to the manipulating of said tubular member.

15. a method for forming a food product, comprising:
providing a cooking insert having a 9- or 6-shape including a generally circular portion and a tail portion;
disposing a first piece of generally flattened dough material on a support having a projection so that a central region of said first piece of generally flattened dough material is located over said projection;
placing said cooking insert on said first piece of generally flattened dough material so that said circular portion encircles said central region and said projection;
depositing a second piece of generally flattened dough material over said first piece of generally flattened dough material and at least said circular portion of the placed cooking insert;
pressing said second piece of generally flattened dough material to said first piece of generally flattened dough material along an inner circle inside said circular portion of said cooking insert and along an outer circle outside said circular portion of said cooking insert; and
cutting said first piece of generally flattened dough material and said second piece of generally flattened dough material proximate to and along said inner circle and said outer circle.

16. The method defined in claim 15 wherein (a) the pressing of said second piece of generally flattened dough material to said first piece of generally flattened dough material and (b) the cutting of said first piece of generally flattened dough material and said second piece of generally flattened dough material are implemented automatically.

17. The method defined in claim 16 wherein (a) the pressing of said second piece of generally flattened dough material to said first piece of generally flattened dough material and (b) the cutting of said first piece of generally flattened dough material and said second piece of generally flattened dough material are performed substantially simultaneously.

18. The method defined in claim 15 wherein the disposing of said first piece of generally flattened dough material and the depositing of said second piece of generally flattened dough material are performed automatically.

19. A bagel filling machine comprising:
a frame;
a plurality of filling containers to said frame;
a pressurization device in operative contact with at least one of said containers for placing pressure on filling held by said one of said containers;
a plurality of valves associated with said containers for controlling release of filling therefrom under pressure applied by said pressurization device.
